(19) United States
(12) Patent Application Publication
(10) Pub. No.: US 2002/0052844 A1
(43) Pub. Date: May 2, 2002

(54) Automation device and method for operating said device

(76) Inventor: Ronald Schoop, Hainburg (DE)

Correspondence Address: DENNISON, SCHEINER, SCHULTZ & WAKEMAN, Suite 612, 1745 Jefferson Davis Highway, Arlington, VA, 22202, US

(21) Appl. No.: 09/978,164

(22) Filed: Oct. 17, 2001

(30) Foreign Application Priority Data
Nov. 2, 2000 (DE) 100 54 328.6

(51) Int. Cl. G06F 17/60; G06F 17/00

(52) U.S. Cl. 705/41; 705/400

(57) ABSTRACT

The invention relates to an automation device (12, 14) such as a memory programmable controller, comprising a control unit (20), which performs operations involving the transmitting and/or receiving of data from peripheral units (30), during a period of operation for the automation device (12, 14). To enable evaluation of the effective use of an automation device, the automation device (12, 14) is equipped with a module (32) for registering the amount of operating time and/or the operations performed by the automation device (12, 14), and the module (32) is coupled to an evaluation unit (38, 46) for calculating a user fee, accrued by the user for use of the automation device (12, 14).

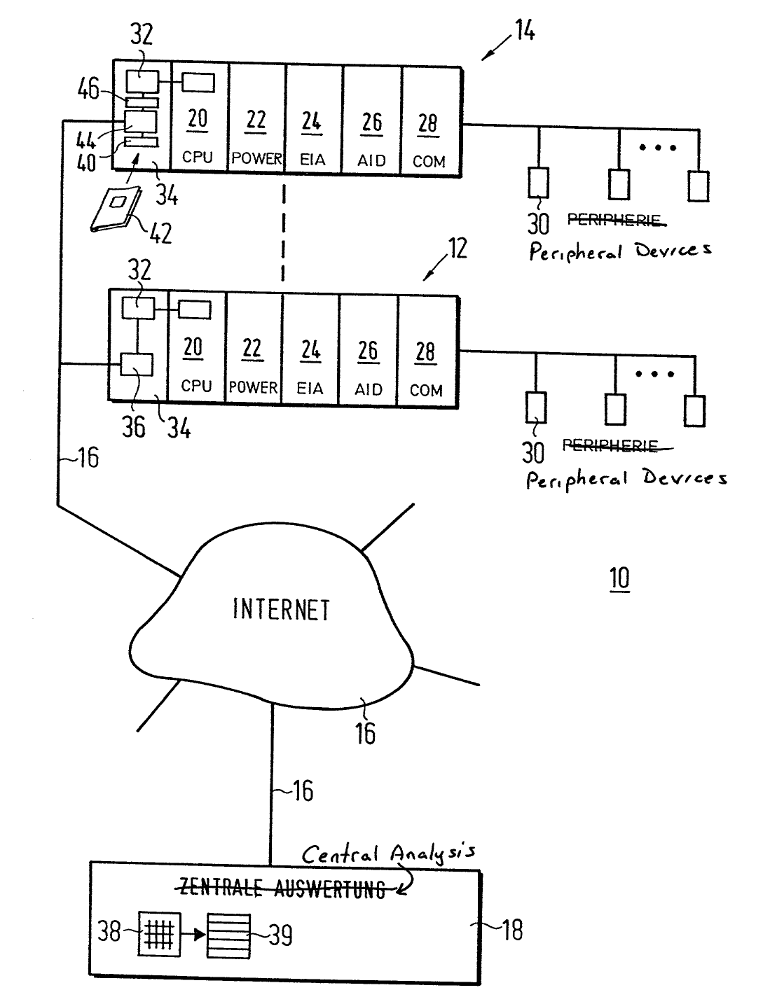

The invention relates to an automation device such as a memory programmable controller, comprising a control unit, used to perform operations involving transmitting and/or receiving data from peripheral units, during a period of operation for the automation device; and a method for operating said automation device.

Automation devices of the type described above are generally sold to a consumer by a manufacturer, allowing the consumer to enjoy unlimited use of the device. Following the sale, the manufacturer may remain responsible for providing service and guarantees for the product. With the steadily and rapidly advancing development of hardware and software components, the disadvantage of this conventional sales method is that the customer must acquire updated hardware and/or software components after only a short period of operation, without having utilized the original components to their full advantage.

The object of the present invention is to provide further development of an automation device of the type described above, such that the marketing possibilities for the automation device are improved and expanded.

The object is attained in accordance with the invention, in that the automation device is equipped with a module for registering the operating time and/or the operations performed by the automation device, and in that this module is coupled to an evaluation unit used to calculate a fee incurred by the user for use of the automation device.

The automation device specified in the invention offers the advantage over the current state of the art, that this device can be rented/leased to a customer, with the customer being charged for only the actual use of the automation device. To this end, a module is provided, which registers the operating time and/or operations performed by the automation device. These data are processed in an evaluation unit and are converted to a user fee, which ultimately is charged to the user.

In accordance with one preferred embodiment of the invention, the module is connected to a centrally located evaluation unit via a data transmission medium, such as a telecommunication connection, preferably the Internet/Intranet. In this manner, a multitude of automation devices can be evaluated at one central point, and the corresponding user fees charged, with these also being transmitted to the customer via the data transmission medium.

An alternative embodiment is advantageously characterized in that the evaluation unit and the module are integrated into a single component, equipped with a memory unit for storing an amount of operating credit and/or a reading unit for a payment card, wherein the operating credit is automatically deducted in correspondence with the operating time and/or operations performed by the automation device.

In order to assign the proper credit amounts to the operating time and/or the operations performed by the automation device, the evaluation unit is provided with a calculating device, such as a calculating table, in which the operating time and/or operations are assigned corresponding debit amounts.

To prevent further use of the automation device once the stored operating credit has been used up, or if fees have not been paid, the module is equipped with a safety device that halts operation of the automation device as soon as the stored operating credit has been used up.

To simplify operation, the component is equipped with a receptacle for the payment card on which a predefined amount of operating credit may be stored. It is also possible to load the operating credit that is on the payment card and/or in the memory unit that is integrated into the component, online or via the data transmission medium.

The data transmission medium is preferably designed to be a telecommunications network, such as the Internet or Intranet, or as a wireless telecommunications connection, such as a radio pathway.

The invention is further related to a method for operating an automation device, which is characterized in that the operating time and/or the operations performed by the automation device are registered, and are evaluated to allow calculation of a user fee, accrued by the user of the automation device.

The registered service data may be transmitted via a data transmission medium to a central point, where they are evaluated, in other words, they are converted to corresponding user fees with the help of a table; it is also possible for the evaluation to be performed on-site, wherein a predetermined amount of credit, which is stored in the automation device or is fed in using a payment card, is debited based upon the operating time and/or the operations performed by the automation device.

It is further possible for the various operations performed by the automation device to be assigned different user fees, with these being stored, for example, in a table either in the automation device itself, or at a central evaluation point.

Further details, advantages, and features of the invention are found not only in the claims and features specified therein—alone and/or in combination—but also in the following description of one exemplary embodiment illustrated in the diagram.

The single diagram shows a purely schematic illustration of a system 10 designed for operating automation devices 12, 14, which offers the possibility of evaluating the automation devices 12, 14 on-site and/or through a data transmission medium 16, such as the Internet and/or Intranet, at a central point 18.

The automation devices 12, 14 comprise a control unit 20, a power supply unit 22, an input/output device 24, an analog-to-digital converter 26, and a communication unit 28, along with a network card. The units 20, 22, 24, 26, 28 serve to control peripheral units 30 such as sensors and actuators of a manufacturing system.

In accordance with the invention, the automation device 12, 14 is equipped with a module 32 for registering the operating time and/or the operations performed by the automation device 12, 14. In particular, the operating time, the cycle times, and load-based cycle times for the control unit 20 are registered. The module 32 is preferably located in a separate component 34 detached from the automation device 12, 14, and which can be interchanged without disrupting operation of the automation device 12, 14. In accordance with the invention, the operating data collected by the module 32 can be evaluated in various different ways.

With the automation device 12, the module 32 is coupled, for example, via a coupling unit 36 to the Internet 16 and ultimately to the central point 18, through which a central polling operation can be performed. Because operating times and/or cycle times are assigned various different values, a comparison of the registered times or cycle times is performed using a calculation table 38, where various uses of the automation device are assigned different user fees. The accrued user fees are added together and stored in a memory unit 39, so that the user fees can be settled with the user via a rendering of accounts, preferably on a monthly basis.

Alternatively, it is possible for the component 34 that holds the module 32 to be equipped with a card reading device 40 designed to receive a payment card 42. This embodiment is implemented in the automation device 14. On the payment card 42, an amount of credit is stored, which can be filed in a temporary memory 44. The operating data registered by the module 32 are converted to user fees via a table stored in a calculating unit 46, with corresponding amounts being deducted from the credit stored in the memory unit 44.

In order to exclude further use of the automation device 14 when the credit has been used up, a locking mechanism is provided which blocks the functioning of the control unit 20.

It is further possible to load credit into the memory unit 44 via the data transmission medium 16, wherein the corresponding equivalent value can be calculated at the central point 18.

1. Automation device (12, 14) such as a memory programmable controller, comprising a control unit (20), which, during a period of operating time for the automation device (12, 14), performs operations involving the transmitting and/or receiving of data from peripheral units (30), characterized in that the automation device (12, 14) is equipped with a module (32) for registering the operating time and/or the operations performed by the automation device (12, 14), and in that the module (32) is coupled to an evaluation unit (38, 46) for calculating a user fee accrued by the user for use of the automation device (12, 14).

2. Automation device in accordance with claim 1, characterized in that the module (32) is connected to the evaluation unit (38), which located at a central point (18), via a data transmission medium (16) such as a telecommunications connection, preferably the Internet/Intranet.

3. Automation device in accordance with claim 1 or 2, characterized in that the evaluating unit (46) is integrated with the module (32) into a component (34), in that the component (34) is equipped with a memory unit (44) used to store an amount of operating credit and/or a reading unit (40) for a payment card (42), and in that the amount of operating credit is automatically deducted in correspondence with the amount of operating time and/or the operations performed by the automation device (14).

4. Automation device in accordance with at least one of the preceding claims, characterized in that the evaluation unit (38, 46) is equipped with a calculating unit such as a calculation table, in which the operating times and/or operations are assigned corresponding debit amounts.

5. Automation device in accordance with at least one of the preceding claims, characterized in that the module (32) is equipped with a safety unit, which halts operation of the automation device (12, 14) as soon as the stored credit has been used up.

6. Automation device in accordance with at least one of the preceding claims, characterized in that operating credit can be loaded into the memory unit (34) [sic] that is integrated in the component (34), online through the data transmission medium (16).

7. Automation device in accordance with at least one of the preceding claims, characterized in that the data transmission medium is designed as a telecommunications network such as the Internet or Intranet, or as a wireless telecommunications connection such as a radio pathway.

8. Method of operation for an automation device (12, 14), characterized in that the operating time and/or the operations performed by the automation device (12, 14) are registered and evaluated for calculation of a user fee, accrued by the user for use of the automation device.

9. Method in accordance with claim 8, characterized in that the registered service data are transmitted via a data transmission medium (16) to a central point (18), or are evaluated on-site in the automation device, wherein the operating time and/or the operations performed are used to calculate user fees, preferably using a calculation table (38), wherein a predetermined amount of credit, stored in the automation device (12, 14) or in the central point (18), or loaded using a payment card (42), is debited in keeping with the operating time and/or operations performed by the automation device (12, 14).
